(19) United States
(12) Patent Application Publication
(10) Pub. No.: US 2006/0161561 A1
(43) Pub. Date: Jul. 20, 2006

(54) Broken Hyperlink auto-redirection and management system and method

(76) Inventor: Stanley Tsai, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/136,480

(22) Filed: May 25, 2005

(30) Foreign Application Priority Data
Jan. 20, 2005 (TW) 094101681

(51) Int. Cl. G06F 17/30

(52) U.S. Cl. 707/100

(57) ABSTRACT

A broken hyperlink auto-redirection and management system and method, which the system includes a hyperlink verify module for verifying a hyperlink and generating a verify result according to a classify result, wherein if type of the hyperlink indicates the hyperlink belonging to a redirection required class so that the classify result is redirection required, the verify result is redirecting; whereas if type of the hyperlink indicates the hyperlink belonging to a redirection refused class so that the classify result is redirection refused, the verify result is recording, and a redirect module, which performs a redirection according to the verify result.

### BACKGROUND OF THE INVENTION

1. Field of Invention

The present invention relates to broken hyperlink management and, in particular, to a system and method performing auto-redirection and management of the broken hyperlink according to type of the hyperlink.

2. Related Art

The Internet becomes a popular tool for communication, and the volume of web document with hyperlink increasing rapidly. The hyperlink helps people to access content with characters, graphics, images, audio signals, and so on, through an URL (uniform resource locator, URL). FIG. 1 is a schematic diagram showing the hyperlink operations a computer system according to the prior art. In general, hyperlink and document of the Internet follows the client-server architecture, herein the client computer 110 is service request sender, and a first server computer 120 is a remote computer providing product information and service for consumer. The client computer having a browser for passing the service request to the first server computer 120, and then the server computer 120 responses to the request sent by the client computer 110. Moreover, the consumer/user may click the hyperlink of the responded content 130 while browsing, the browser accessing the address of the first server computer 120 for retrieving the content indicated by the hyperlink, the first server computer 120 accessing a second server computer 140, and then responses and displays the intended content to the client computer 110.

As the international communications unimpeded, the commercial activities increase frequently. For manufacturing and marketing industry, there are many manufacturers and their customers having business transactions via Internet. For instance, a chip design or manufacturer A may provide associated product information for a customer B manufacturing a main board with the chip or selling a laptop computer, and then the customer B may broadcasts the information on their own website for consumer to browse and access, and hence retrieve more details associated with the information through the hypertext accessed by the browser. If the web page removed because of version update and product go out the market, the invalid or broken hyperlink result in the bad feeling and appraisal of consumer, and the direct indirect damage of the goodwill of firm A and B.

In General, the content provider dynamically updates content and path of web page, and the search engine updates corresponding indexes for the correctness of the hyperlink, or the broken link appears. There are some different situations turns up as follows. Firstly, the user may obtain the messages such as “web page not found”, “return to last page”, and “select other hyperlink” since the broken link appearing, and it is inconvenient for the user. Secondly, server may provide other preset hyperlink for user to redirect to the preset hyperlink manually, but it is inflexible expensive to store the recovery program, hard to maintain, and inconsistent of the file directory after many redirection. Moreover, the update cost, load and consumption of system resource increasing while the quantity of client computer more than one. Furthermore, the verification of hyperlink normalization according to the error message manually will cause inefficiency, response delay, and man-made faults.

Accordingly, the inflexible and inefficient hyperlink update method consumes huge amount of resource, and hence the development of an efficient broken hyperlink auto-redirection and management system for a web page is imperative.

### SUMMARY OF THE INVENTION

In view of the foregoing, the invention is to provide a broken hyperlink auto-redirection and management system applies to a web page provider, which includes a hyperlink verify module verifying a hyperlink and generating a verify result according to a classify result, and a redirect module performing a redirection according to the verify result. It's noted that if type of the hyperlink indicates the hyperlink belonging to a redirection required class so that the classify result is redirection required, and the verify result is redirecting, whereas if type of the hyperlink indicates the hyperlink belonging to a redirection refused class so that the classify result is redirection refused, and the verify result is recording. Moreover, the broken hyperlink auto-redirection and management system of the present invention may further include a hyperlink receive module for receiving the hyperlink, a classify module for classifying the hyperlink for generating the classify result, a first record module for recording the hyperlink to a log file while the verify result is recording, a redirection setting module for setting and storing a redirection hyperlink, a search module for searching the redirection hyperlink stored in the redirection setting module for generating a search result, a second record module for recording the redirection hyperlink to a setting area while the search result is the redirection hyperlink not found in the redirection setting module, a notice delivery module for transmitting a notice to a web master, a user interface for a web master to access the redirection hyperlink in the redirection setting module, and a count module for counting times of the redirection for generating a hyperlink information.

In addition, the invention further provides a broken hyperlink auto-redirection and management method, which includes the steps of verifying a hyperlink and generating a verify result according to a classify result, and performing a redirection according to the verify result. It's noted that if type of the hyperlink indicates the hyperlink belonging to a redirection required class so that the classify result is redirection required, and the verify result is redirecting, whereas if type of the hyperlink indicates the hyperlink belonging to a redirection refused class so that the classify result is redirection refused, and the verify result is recording. Furthermore, the broken hyperlink auto-redirection and management method of the present invention includes the steps of: receiving the hyperlink, classifying the hyperlink for generating the classify result, recording the hyperlink while the verify result is recording, setting and storing a redirection hyperlink for the redirection, searching the redirection hyperlink for generating a search result, recording the redirection hyperlink while the search result is the redirection hyperlink not found, transmitting a notice while the search result is the redirection hyperlink not found, and counting the redirection for generating a hyperlink information.

Accordingly, the broken hyperlink auto-redirection and management system and method of the present invention having the advantages listed as fellows. Firstly, the improvement and maintenance of firms' goodwill, users' consumption rights, operating experience and convenience may be achieved. Secondly, the broken hyperlink auto-redirection and management system and method of the present invention have the functions for counting, recording, dynamically updating the hyperlink type and invocation times for other applications and system robustness, and hence the costs and web master's load may be reduced as well.

### BRIEF DESCRIPTION OF THE DRAWINGS

The invention will become more fully understood from the detailed description given herein below illustration only, and thus is not limitative of the present invention, and wherein:

FIG. 1 is a schematic view showing hypertext system of web environment according to a preferred embodiment of the prior art.

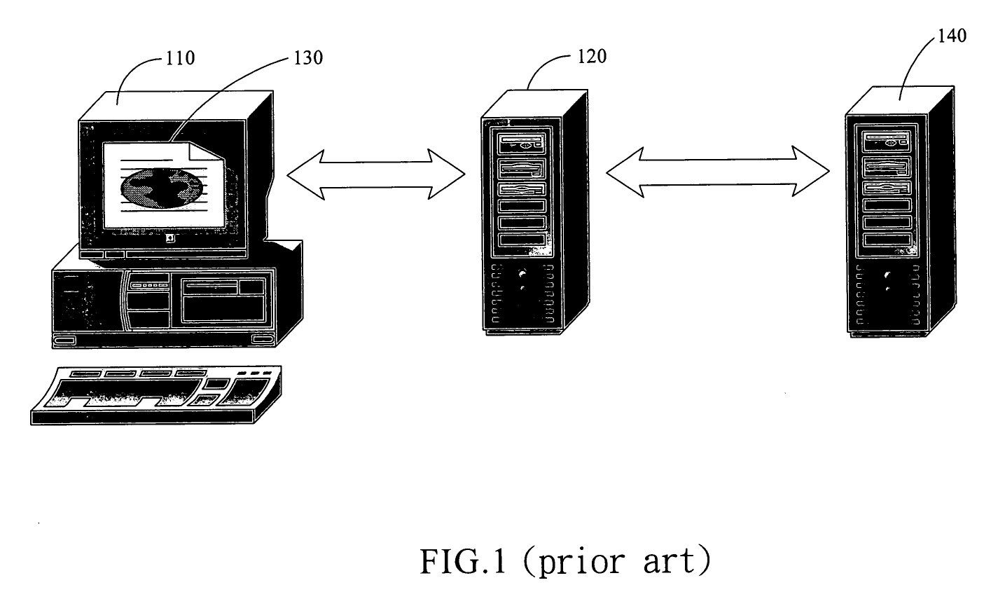

FIG. 2 is a block diagram showing a broken hyperlink auto-redirection and management system according to a preferred embodiment of the invention.

FIG. 3 is a flow chart showing the steps of the broken hyperlink auto-redirection and management method according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

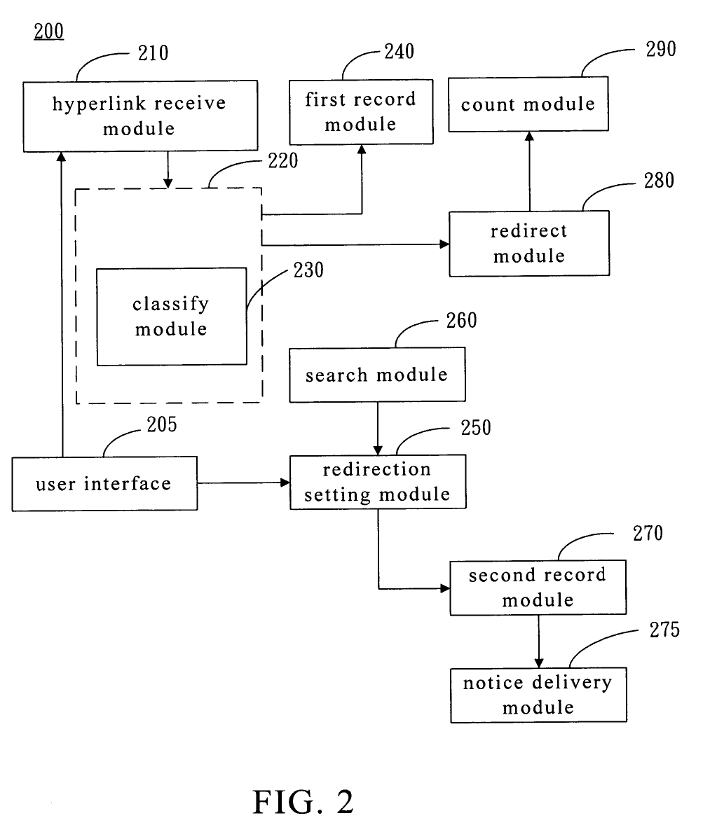

With reference to FIG. 2, a block diagram showing a broken hyperlink auto-redirection and management system 200 applies to a web page provider such as a server includes a user interface 205 for a web master to access a hyperlink receive module 210 which receives the hyperlink sent from a hypertext and a redirection setting module 250 which sets and stores a redirection hyperlink, a hyperlink verify module 220 for verifying the hyperlink received by the hyperlink receive module 210 and generating a verify result according to a classify result generated by a classify module 230; and a redirect module 280 for performing the redirection stored in the redirection setting module 250 according to the verify result. It's noted that if type of the hyperlink indicates the hyperlink belonging to a redirection required class so that the classify result is redirection required, and the verify result is redirecting, whereas if type of the hyperlink indicates the hyperlink belonging to a redirection refused class so that the classify result is redirection refused, and the verify result is recording. For example, if the hyperlink has a sub-filename such as “html” or “gif” satisfying to a given judging rule determined by the web master, the broken hyperlink may be auto-redirected.

Moreover, the broken hyperlink auto-redirection and management system 200 may further include a first record module 240 for recording the hyperlink to a log file while the verify result is recording. For example, if there is a broken hyperlink having a sub-filename such as “123” sending by a hacker that unsatisfying to a given judging rule determined by the web master, the redirection of the broken hyperlink may be refused and recorded to the log file for other application. Furthermore, the broken hyperlink auto-redirection and management system 200 includes the redirection setting module 250 mentioned above for setting and storing the redirection hyperlink for the redirection performed by the redirect module 280, a search module 260 for searching the redirection hyperlink stored in the redirection setting module 250 for generating a search result, and a second record module 270 for recording the redirection hyperlink to a setting area while the search result is the redirection hyperlink not found in the redirection setting module 250, a count module 290 for counting times of the redirection for generating a hyperlink information, and a notice delivery module 275 for transmitting a notice to the web master.

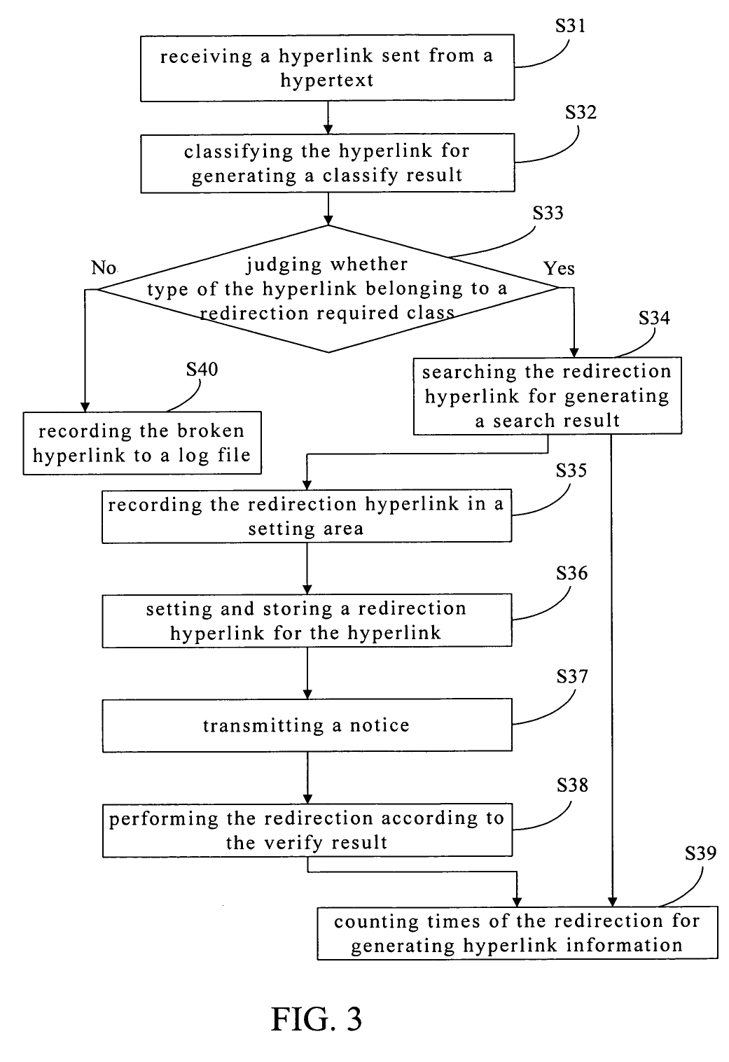

With reference to FIG. 3, a flow chart showing the steps of the broken hyperlink auto-redirection and management method according to a preferred embodiment of the invention includes the steps of receiving a hyperlink sent from a hypertext in step S31, classifying the hyperlink for generating a classify result in step S32, verifying the hyperlink and generating a verify result according to the classify result in step S33, where if type of the hyperlink indicates the hyperlink belonging to a redirection required class so that the classify result is “redirection required”, the verify result is “redirecting”, whereas if type of the hyperlink indicates the hyperlink belonging to a redirection refused class so that the classify result is “redirection refused”, the verify result is “recording”; if the verify result is “redirecting” as mentioned above, searching the redirection hyperlink for generating a search result in step S34, recording a redirection hyperlink in a setting area while the search result is the redirection hyperlink not found in the redirection setting module in step S35, setting and storing a redirection hyperlink for the hyperlink in step S36, transmitting a notice while the search result is the redirection hyperlink not found in step S37, and performing the redirection according to the verify result in step S38 so that the auto-redirection is completed. Besides, if the verify result is redirecting and the search result is found in step S34, executing the step S38 for performing the redirection, and counting times of the redirection for generating hyperlink information for other applications in step S39. In the other hand, if the classify result is redirection refused so that the verify result is recording in the step S33, executing the step 40 for recording the broken hyperlink to a log file.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A broken hyperlink auto-redirection and management system applies to a web page provider, comprising:
a hyperlink verify module, which verifies a hyperlink and generates a verify result according to a classify result, wherein if type of the hyperlink indicates the hyperlink belonging to a redirection required class so that the classify result is redirection required, the verify result is redirecting; whereas if type of the hyperlink indicates the hyperlink belonging to a redirection refused class so that the classify result is redirection refused, the verify result is recording; and
a redirect module, which performs a redirection according to the verify result.

2. The system of claim 1, further comprising:
a hyperlink receive module, which receives the hyperlink.

3. The system of claim 1, wherein the hyperlink verify module further comprising:
a classify module, which classifies the hyperlink for generating the classify result to the hyperlink verify module.

4. The system of claim 1, further comprising:
a first record module, which records the hyperlink to a log file while the verify result is recording.

5. The system of claim 1, further comprising:
a redirection setting module, which sets and stores a redirection hyperlink for the redirection performed by the redirect module.

6. The system of claim 5, further comprising:
a search module, which searches the redirection hyperlink stored in the redirection setting module for generating a search result; and
a second record module, which records the redirection hyperlink to a setting area while the search result is the redirection hyperlink not found in the redirection setting module.

7. The system of claim 6, wherein the second record module further comprising:
a notice delivery module, which transmits a notice to a web master.

8. The system of claim 5, further comprising:
a user interface, which allows a web master to access the redirection hyperlink in the redirection setting module.

9. The system of claim 1, further comprising:
a count module, which counts times of the redirection for generating a hyperlink information.

10. The system of claim 1, wherein the web page provider is a server.

11. A broken hyperlink auto-redirection and management method, comprising:
verifying a hyperlink and generating a verify result according to a classify result, wherein if type of the hyperlink indicates the hyperlink belonging to a redirection required class so that the classify result is redirection required, the verify result is redirecting; whereas if type of the hyperlink indicates the hyperlink belonging to a redirection refused class so that the classify result is redirection refused, the verify result is recording; and
performing a redirection according to the verify result.

12. The method of claim 11, further comprising:
receiving the hyperlink.

13. The method of claim 11, further comprising:
classifying the hyperlink for generating the classify result.

14. The method of claim 11, further comprising:
recording the hyperlink while the verify result is recording.

15. The method of claim 11, further comprising:
setting and storing a redirection hyperlink for the hyperlink.

16. The method of claim 15, further comprising:
searching the redirection hyperlink for generating a search result; and
recording the redirection hyperlink to a setting area while the search result is the redirection hyperlink not found in the redirection setting module.

17. The method of claim 16, further comprising:
transmitting a notice while the search result is the redirection hyperlink not found.

18. The method of claim 11, wherein the broken hyperlink auto-redirection and management method applies to a web page provider.

19. The method of claim 18, wherein the web page provider is a server.

20. The method of claim 11, further comprising:
counting times of the redirection for generating a hyperlink information.
